(19) United States
(12) Patent Application Publication
(10) Pub. No.: US 2026/0112781 A1
(43) Pub. Date: Apr. 23, 2026

(54) BATTERY MODULE OF THE TYPE THAT CAN BE DISASSEMBLED AND BATTERY PACK OBTAINED ASSEMBLING AT LEAST TWO SUCH BATTERY MODULES

(71) Applicant: HYBA LTD., London (GB)

(72) Inventors: Edoardo GNESI, San Giuliano Terme (IT); Daniele CALDERONI PARRONCHI, Firenze (IT); Andrea GROSSO, London (GB); Costanza HERMANIN DE REICHENFELD, Impruneta (IT); Francesco BORTONE, Milano (IT); Michele PERANI, Bergamo (IT)

(73) Assignee: HYBA LTD., London (GB)

(21) Appl. No.: 19/118,725

(22) PCT Filed: Oct. 4, 2023
(86) PCT No.: PCT/IB2023/059964

§ 371 Date: Apr. 4, 2025

(30) Foreign Application Priority Data
Oct. 6, 2022 (IT) 102022000020550

(51) Int. Cl. H01M 50/507; H01M 10/48; H01M 50/258; H01M 50/517; H01M 50/524; H01M 50/548

(52) U.S. Cl. CPC H01M 50/507; H01M 10/482; H01M 10/486; H01M 50/258; H01M 50/517; H01M 50/524; H01M 50/548

(57) ABSTRACT

A battery module including multiple cells arranged according to at least one row, each cell having a positive terminal and a negative terminal positioned at opposite ends. A first and a second connection bar, or busbar, are provided electrically connected to the positive terminals and to the negative terminals of the cells. Support bodies are provided with respective conductive elements which include a respective connection portion and multiple contact portions. An engagement group is provided that removably mechanically engages the support bodies in a predetermined working position, in which the connection portions are mechanically forced to be arranged in contact with the first, or the second, connection bar, and each contact portion to be arranged in contact, with a respective positive terminal or with a respective negative terminal such that the electrical connection between the first and the second connection bar and the plurality of cells.

### FIELD OF THE INVENTION

The present invention relates to the industrial field of the supply devices for the sector of electric or hybrid vehicles, and in particular it relates to a module cells of the type that can be disassembled.

The invention, furthermore, relates to a battery pack obtained by assembling together more battery modules.

### BACKGROUND OF THE INVENTION

As it is known, several typologies of battery packs exist, also called multi-cells batteries, which are, in particular, used to supply electrical devices of different type, and in particular electric or hybrid vehicles, such as bicycles, motorcycles, and in general vehicles with 2, or more wheels.

In particular, in the case of electric or hybrid vehicles, these comprise one, or more, rechargeable battery packs, which supply the vehicle propulsion device. Normally, a battery pack is formed by a determined number of cells connected in series and/or in parallel in such a way to form as a whole a battery with a high store capacity of electrical energy, or to reach high values of the supplied electric power.

The different cells forming the battery pack can be held together by a wrapper made of plastic, or can be housed within a containment body.

The battery pack is normally associated to a control and management unit, normally indicated with the English acronyms BMS which stands for “Battery Management System”, which controls the critical functions of the cells, in particular that the cells work in the correct balancing condition, in addition to control that the charging and discharging processes of each cell occur correctly, and to manage the communication with the external units.

Normally, a battery pack is obtained by connected in series the different battery modules each of which formed by a determined number of cells. Generally, each battery module provides a determined number of connecting bars, or busbars, which are made of a conductive material, normally copper, that are connected, normally by welding to respective leads of the conductive cable, to the positive terminals, or to the negative terminals, of the different cells of the pack in order to obtain a determined electrical connection scheme, for example, to connect in parallel to each other the different cells of the pack. In practice, the connection bars are long conductors insulated from the ground that collect and transmit the high current supplied by each of the cells forming a battery module.

A first drawback of the aforementioned type of the battery packs is the complex and long process needed to carry out the necessary welding, in fact, especially in the case of battery packs for electric vehicles, a battery pack is formed by hundreds of cells.

Furthermore, if the welding is not carried out correctly, it is possible to have large losses of efficiency of the battery pack and/or a reduction in the life of the battery. In particular, the presence also of small zones with high resistance at the welding zone can generate an amount of heat sufficient to degrade the battery and to cause early damages.

A further drawback of the battery packs as described above, that means obtained by assembling together and electrically connecting by welding the different parts which form the same, is that it is not possible to easily and quickly disassemble the different parts in order to carry out an ordinary or extraordinary maintenance operation and to proceed, in case, to replace of one or more damaged or worn components with new components.

Another drawback of the prior art battery packs is that, in order to be able to carry out the aforementioned control and management functions, a BMS unit is, normally, provided with one or more voltage sensors in particular to control the balance of the cells, and with one or more temperature sensors to control the temperature of the cells and to be able to immediately intervene if too high temperatures are measured thus avoiding damages, or fires, and guaranteeing this way that the necessary safety conditions are met.

However, the aforementioned sensors, in addition to the connectors that are necessary to be connected with other units, and the presence of microcontrollers make the prior art BMS unit cumbersome and expensive.

In the prior art solutions, which provide a connection of the connection bars or busbar without welding, the contact force with the terminal of the cell is exerted by an element made of metallic conductive material, generally a thin plate made of copper. However, the thin plate made of copper reaches the yield point with low loads losing the pre-set elastic force, i.e. has a low yield point which causes the contact force of the busbar on the terminal of the cell to be reduced.

Instead, in other cases, the elastic elements of contact are made of steels more or less harmonic in such a way to guarantee a constant compression. However, this type of material has an electrical resistance that is higher than the copper and causes overheating and losses of yield.

An example of a battery pack where both the electrical contact and the elastic force among the cells and the other components of the system is obtained by an element made of a metallic material is described in US2021083248. More precisely, the electrical contact among the terminals of the cells and a connection plate is provided by an element of contact made of a metal with elastic properties, in particular an elastic thin plate which is bent in such a way that the surfaces of contact of the cells are arranged at a determined angle with respect to each other. This assembly situation, in addition to the aforementioned drawbacks, on the basis of the expansions of the cells or the vibrations could produce micro-fretting phenomena. As it is known, with the expression “fretting corrosion” it is meant that a kind of damage that is caused by wear and, sometimes, by corrosion of the contact surfaces, in presence of small periodic movements of friction or collision, which, when the current is passing, produce micro-arching. Instead, in the absence of a corrosive environment we talk about “fretting”.

The result of the aforementioned two effects combined with each other can be an uncontrolled overheating of the terminal of the cell and a wear of the same. In addition to the above, the micro-welding which are created in this way increase the resistance of the connection, thus increasing the temperatures and creating a sort of “knock-on effect” which prejudices the correct functioning of the battery pack.

### SUMMARY OF THE INVENTION

It is therefore an object of the present invention to provide a battery module which is able to overcome the aforementioned drawbacks of the prior art solutions.

It is another object of the present invention to provide a battery module, in particular but not only for supplying electric vehicles, that allow to quickly and easily disassemble its components to be able to carry out ordinary and extraordinary maintenance operations, and that is able, at the same time, to assemble again the components at the end of the operation, after having, in case, carried out the replacement of one or more worn or damaged components, with components perfectly working.

It is also an object of the present invention to provide a battery pack that is obtained by assembling together more battery modules having analogous advantages.

These and other objects are achieved by a battery module comprising:
a plurality of cells, in particular arranged according to at least one row, each cell of said plurality having a positive terminal and a negative terminal positioned at opposite ends;
a first and a second connection bar, or busbar, positioned at opposite ends of the cells of the aforementioned plurality and configured to be electrically connected, respectively, to said positive terminals and to said negative terminals of said plurality of cells;
a plurality of support bodies each of which comprising a respective plurality of housing portions configured to house, in use, respective end portions comprising said positive terminal, or said negative terminal, of a respective cell of said plurality of cells;

whose main characteristic is that each support body of said plurality is provided with a respective conductive element made of a conductive material and comprising a respective plurality of contact portions, each contact portion of said plurality being adapted to be positioned, in use, adjacent to a respective positive terminal, or to a respective negative terminal, of a respective cell of said plurality of cells;

that each conductive element comprises a respective connection portion;

that an engagement group is, furthermore, provided configured to move between a disengagement configuration, where said plurality of support bodies are not engaged to each other, and an engagement configuration, where said engagement group is arranged to removably mechanically engage said plurality of support bodies in a predetermined working position, where said connection portions of said conductive elements are mechanically forced to be positioned in contact with said first or said second connection bar, or busbar, and each contact portion to be arranged in contact with a respective positive terminal, or with a respective negative terminal, of said plurality of cells, in such a way to provide the electrical connection between said first and said second connection bar, or busbar, and said plurality of cells;

that at least one support body of the aforementioned plurality is provided with a cavity arranged to house, in use, a respective contact portion of said conductive element;

and that at each said cavity an elastic element made of an elastomeric material is provided arranged to resiliently force the respective contact portion towards the positive or the negative terminal H the respective cell along a direction axial to said cell, in such a way to guarantee the aforementioned electrical connection.

Other features of the invention and related embodiments are set out in the dependent claims.

Advantageously, the engagement group can comprise at least a support plate. In particular, the or each support plate and the first and second connection bars are configured to mechanically engage with each other. For example, the or each support plate can be adapted to mechanically engage with clearance, or carrying out a positive engagement, into an opening provided at each connection bar, or busbar.

More in particular, on the or each support plate at least one temperature sensor can be mounted that is configured to detect the temperature of at least a part of the aforementioned plurality of cells and to generate a corresponding temperature signal.

In addition, or alternatively, to the or each temperature sensor on the or each support plate, at least one adjustment member can be mounted configured to adjust the balancing current of said plurality of cells, or a part of this. More precisely, the management unit can be configured to operate the adjustment element of the balancing current, for example a resistance, in such a way to divert on it the energy of that section.

More in particular, in addition to the or each aforementioned temperature sensor, and/or the or each adjustment element of the balancing current, and on the or each support plate, at least one connector can be mounted configured to connect the or each temperature sensor and/or the or each adjustment element of the balancing current to said battery management unit or BMS. In this way, the battery management unit or BMS can receive the signal of temperature and/or the signal of voltage, in particular to process the same and to carry out the known operations of controlling of the temperature and of balancing of the cells, which are normally carried out by the prior art BMS. However, with respect to the BMS which are generally provided in the prior art battery packs, the technical solution according to the present invention of mounting the or each temperature sensor and/or the or each adjustment element of the balancing current on the support plate allows to considerably reduce the number of the components that are present on the BMS, thus considerably reducing its size and its cost. More precisely, the BMS does not have the electronic components which operate both the balance of the different groups of cells and the detection of the temperature. It is, therefore, a BMS “lightened” from the resistances, from the sensors of temperature and from the components which adjust the balance among the groups of cells. These resistances and the components are, in fact, relocated and positioned on the card of each battery module. The BMS maintains the functions of processing the temperature signals and the inlet voltage only, and provides the exiting balancing order as a response.

In particular, the aforementioned engagement group can comprise, furthermore, first engagement elements configured to removably mechanically engage the or each support plate to at least a part of the aforementioned plurality of support bodies.

Advantageously, the engagement group can comprise, furthermore, second engagement elements configured to removably mechanically engage at least one between the first and the second connection bar, or busbar, to the first and second support bodies.

In particular, a first support body and at least a second support body can be provided. More in particular, the engagement group can be configured to engage the first and the second support body to the same side of the same support plate.

In an embodiment foreseen by the invention, the aforementioned plurality of cells can be organized according to a first and a second row of cells.

In this case, the battery module can comprise, furthermore:
a third support body provided with a third conductive element and positioned at the opposite side of the first support body with respect to the first connection bar, or busbar;
a fourth support body provided with a fourth conductive element and positioned at the opposite side of the second support body with respect to said second connection bar, or busbar.

More in particular, the conductive elements of the third and the fourth support body can comprise a respective plurality of contact portions. In particular, each contact portion of the third support body is adapted to be arranged, in use, adjacent to a respective positive terminal of a respective cell of said plurality of cells, and each contact portion of the fourth support body is adapted to be arranged, in use, in contact with a respective negative terminal of the aforementioned plurality of cells.

In particular, in this case, the engagement group can be, furthermore, configured to removably mechanically engage, in the engagement configuration, with the third and fourth support bodies. In the working position, the third and fourth support bodies are adapted to force the third and fourth connection portions of the third and fourth conductive elements to be positioned in a respective connection position, where they are, respectively, positioned in contact with the first connection bar and with the second connection bar, or busbar, and the contact portions of the third and of the fourth plurality to be arranged in contact, respectively, with respective said positive terminals and respective negative terminals of the plurality of cells.

In particular, the aforementioned elastomeric material, or rubber, can be a thermoplastic elastomeric material.

In an embodiment foreseen by the invention, the elastic material is Styrene-ethylene-butylene-styrene (SEBS).

Advantageously, in use, each elastic element can be arranged to resiliently force the respective contact portion towards the positive or negative terminal of the respective cell, in such a way to guarantee the electrical connection among the components.

In particular, during the movement of the engagement group from the disengagement configuration to the engagement configuration, the or each elastic element is elastically pressed. In this way, on the one hand, the axial block is carried out of the cells of the battery module to the support bodies, and on the other hand, the necessary electrical connection among the cells same and the electric components of the battery module is guaranteed.

In a possible embodiment, of the invention, the aforementioned first engagement elements can comprise:
a plurality of engagement holes made in the or each support plate;
a plurality of protruding portions, each of which adapted to protrude from each support body of the aforementioned plurality and configured to engage, in the aforementioned engagement configuration of the engagement group, in a respective engagement hole of the aforementioned plurality of engagement holes of the aforementioned support plate.

According to another aspect of the invention, a battery pack, according to the invention, comprises a first and at least a second battery module as described above.

In particular, the first battery module is positioned above the second battery module and the second connection bar, or busbar, of the first battery module coincides with the first connection bar, or busbar, of the second battery module.

More in particular, the aforementioned second connection bar, or busbar, of the first battery module can comprise:
an upper connection portion configured to be electrically connected to said negative terminals of said plurality of cells of said first battery module; and
a lower connection portion configured to be electrically connected to said positive terminals of said plurality of cells of said second battery module.

In particular, the aforementioned upper connection portion and the aforementioned lower connection portion of the second connection bar, or busbar, of the first battery module, are adapted to connect in series the first battery module and the second battery module.

Advantageously, the battery pack comprises, furthermore, a management unit or BMS configured to receive the temperature signals and/or the signals of voltage, if any, by the sensors of temperature and by the sensors of voltage, if present at the different battery modules which form the battery pack, and to activate the or each adjustment member to adjust the balancing current among the different cells in such a way to balance the voltage. Therefore, in practice the BMS unit is adapted to manage the charging and the discharging of the cells of the pack, in particular of each battery module which form the same, to avoid that predetermined threshold values can be exceeded.

According to a further aspect of the invention, a method for manufacturing a battery module comprises the steps of:
positioning a plurality of cells according to at least a row, each cell of said plurality having a positive terminal and a negative terminal positioned at opposite ends;
disposing of a first and a second connection bar, or busbar, positioned at opposite end portions of said battery module and configured to be respectively electrically connected to said positive terminals and to said negative terminals of said plurality of cells;
disposing of a plurality of support bodies each of which comprising a respective plurality of housing portions configured to house, in use, a respective end portion comprising said positive terminal, or said negative terminal, of a respective cell of said plurality of cells, each support body of said plurality being provided with a respective conductive element made of a conductive material and comprising a respective plurality of contact portions and a respective connection portion, each contact portion of said plurality being adapted to be positioned, in use, adjacent to a respective positive terminal, or to a respective negative terminal of a respective cell of said plurality of cells;
removably mechanically engaging said plurality of support bodies to mechanically force said connection portions of said conductive elements to be arranged in contact with said first connection bar, or with said second connection bar, or busbar, and each said contact portion to be arranged in contact, with a respective positive terminal or with a respective negative terminal of said plurality of cells, in such a way to carry out the electrical connection between said first and said second connection bar, or busbar, and said plurality of cells;

wherein said mechanical engagement is carried out by resiliently forcing by an elastic element made of an elastomeric material and which is housed within a cavity made in at least a support body of said plurality, a respective contact portion of said conductive element towards said positive or negative terminal of said respective cell along a direction axial to said cell, in such a way to guarantee the electric connection.

### BRIEF DESCRIPTION OF THE DRAWINGS

The invention will be now illustrated with the following description of an exemplary embodiment thereof, exemplifying but not limitative, with reference to the attached drawings wherein:

FIG. 1A diagrammatically shows a perspective side elevation view of a first embodiment of the battery module provided by present invention in an engagement configuration;

FIG. 1B diagrammatically shows a perspective side elevation view of a possible embodiment of a cell of which the battery module of FIG. 1A can be provided in working conditions;

FIG. 2 diagrammatically shows a perspective side elevation view of the embodiment of the battery module of FIG. 1 in an exploded configuration;

FIG. 3A diagrammatically shows a plan perspective view of a possible conductive element foreseen by the present invention for the battery module according to the invention;

FIG. 3B diagrammatically shows a plan perspective view of a possible embodiment of a support body of which the battery module, according to the invention, is provided with the respective conductive element;

FIG. 4A diagrammatically shows a perspective side elevation view of an alternative embodiment of the battery module of FIG. 1A foreseen by the present invention in an engagement configuration;

FIG. 4B diagrammatically shows a perspective side elevation view of a possible embodiment of the connection bars, or busbar, which can be used in the alternative embodiment of FIG. 4A;

FIG. 5 shows a plan view of the battery module of FIG. 4A;

FIG. 6 shows a side elevation view of the battery module of FIG. 4A;

FIG. 7 diagrammatically shows a cross section view according to the arrows VII-VII of the battery module of FIG. 5;

FIG. 8 diagrammatically shows an enlargement of the FIG. 7 to highlight some technical characteristics;

FIG. 9 diagrammatically shows a cross section view according to the arrows IX-IX of the battery module of FIG. 6

FIG. 10 diagrammatically shows an enlargement of the FIG. 9 to highlight some technical characteristics;

FIG. 11 diagrammatically shows a perspective side elevation view of a battery pack that can be obtained by assembling together more battery modules according to the invention;

FIG. 12 diagrammatically shows a side elevation view of an alternative embodiment of the battery pack of FIG. 11;

FIG. 13 shows an enlargement of a cross section according to the arrows XIII-XIII of a part of the battery pack of FIG. 12;

la FIG. 14 diagrammatically shows a perspective side elevation view of a possible alternative embodiment of the elastic element according to the invention;

FIG. 15 diagrammatically shows a perspective side elevation view of an embodiment of a group of conductive elements associated to the same support body;

FIG. 16 shows a perspective view of a possible embodiment of a support body according to the invention;

FIG. 17 diagrammatically shows a perspective side elevation view of an embodiment of a battery module obtained by using the support body of FIG. 16;

FIG. 18 diagrammatically shows a perspective side elevation view of an enlargement of a part of the FIG. 17 where a support body has been removed to show some technical characteristics of the elastic element and of the conductive elements that are used.

### DETAILED DESCRIPTION OF SOME EXEMPLARY EMBODIMENTS OF THE INVENTION

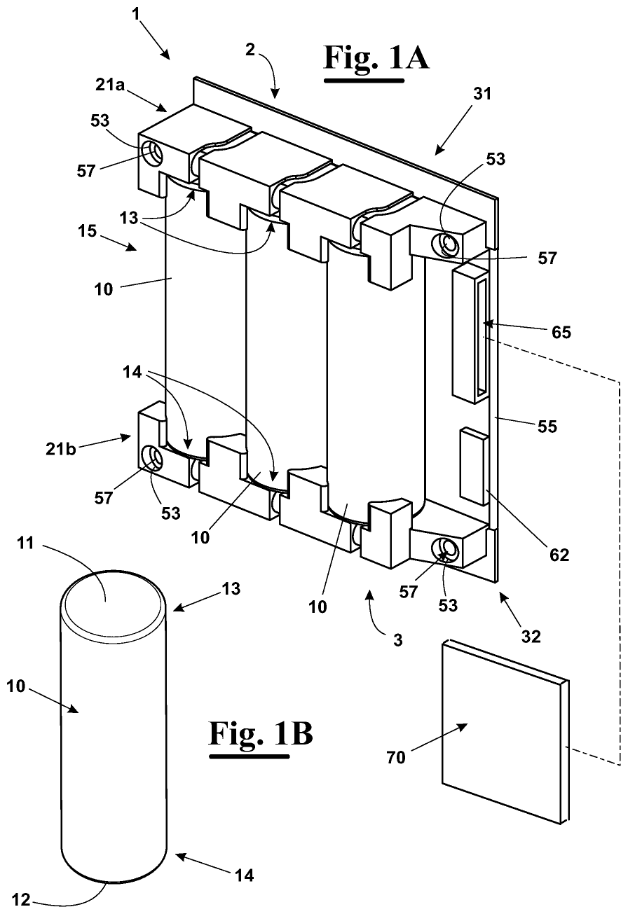

With reference to the FIGS. 1A and 1B, a first embodiment of a battery module 1, according to the invention, comprises a plurality of cells 10, for example 3 cells 10 having a cylindrical geometry,, arranged according to a predetermined number of rows 15, in the example of figures and 2, according to a single row 15. In particular, the cells 10 of each row 15 are, advantageously, positioned vertically one next to the other.

Each cell 10 of the aforementioned plurality has a positive terminal 11 and a negative terminal 12 positioned at opposite ends 13 and 14, going along an axial direction 110. Even if in the FIGS. 1A and 1B cells with a cylindrical geometry are shown, the present invention does not exclude that the same inventive concept can be also applied to cells with a different geometry, for example cells 10 with prismatic geometry, case that is not shown in detail in the FIGS. from 1A to 11 for simplicity, but of known type for a skilled person in the technical field.

The battery module 1 comprises, furthermore, a first connection bar 31, or busbar, positioned at a first end portion 2 of the battery module 1 and configured to be electrically connected to the different positive terminals 11 of the aforementioned plurality of cells 10, and a second connection bar 32, or busbar, positioned at a second end portions 3 of the battery module 1, in particular opposite to the first end portion 2 with respect to a transversal plane, and configured to be electrically connected to the negative terminals 12 of the cells 10, in such a way that is possible to connect in parallel the different cells 10 of the battery module 1.

The battery module 1 can provide, furthermore, a plurality of support bodies 21, for example a first and a second support body 21a and 21b, each of which comprising a respective plurality of housing portions, for example 3 housing portions 23 and 24. In particular, each support body 21 can be made of a plastic material, in particular a polymeric material, for example polyamide, in particular Nylon, advantageously Glass filled Nylon, material having a high structural resistance, or polybutylene-terephthalate (PBT), advantageously PBT GF20.

Each housing portion 23 is adapted to house, in use, a first end portion 13 comprising the positive terminal 11 of a respective cell 10 of the aforementioned plurality of cells, whilst each housing portion 24 is adapted ad house, in use, a second end portion 14 comprising the negative terminal 12 of a respective cell 10 of the plurality of cells. More precisely, each housing portion 23, or 24, can be laterally delimited by a determined number of containment walls 29, advantageously curvilinear in the case of cylindrical cells 10, in such a way to fit with the external surface of the cell 10 to be housed.

According to what is foreseen by the invention, each support body 21 is associated to a respective conductive element 41. Each conductive element 41 is made of a conductive material, for example copper, advantageously nickel-plated copper, and is configured to electrically connect the first, or the second connection bar 31, or 32, to the positive terminals 11, or to the negative terminals 12, of the plurality of cells 10. More in particular, each conductive element 41 comprises a respective plurality of contact portions, for example 3 contact portions 43. The contact portions 43 of a conductive element 41 are adapted to be positioned, in use, adjacent to the positive terminals 11, or to the negative terminals 12, of the cells 10. More precisely, the 3 contact portions 43 of the conductive element 41 of the first support body 21a can be arranged, in use, in contact with respective positive terminals 11 of respective cells 10, and the 3 contact portions 43 of the conductive element 41 of the second support body 21b can be positioned, in use, in contact with respective negative terminals 12 of respective cells 10, in such a way to be in electrical contact with the same.

More precisely, each contact portion 43 of the conductive element 41 of the first support body 21a and each contact portion 43 of the conductive element 41 of the second support body 21b, is positioned, in use, at a respective housing portion 23 of the respective support body 21a-21b.

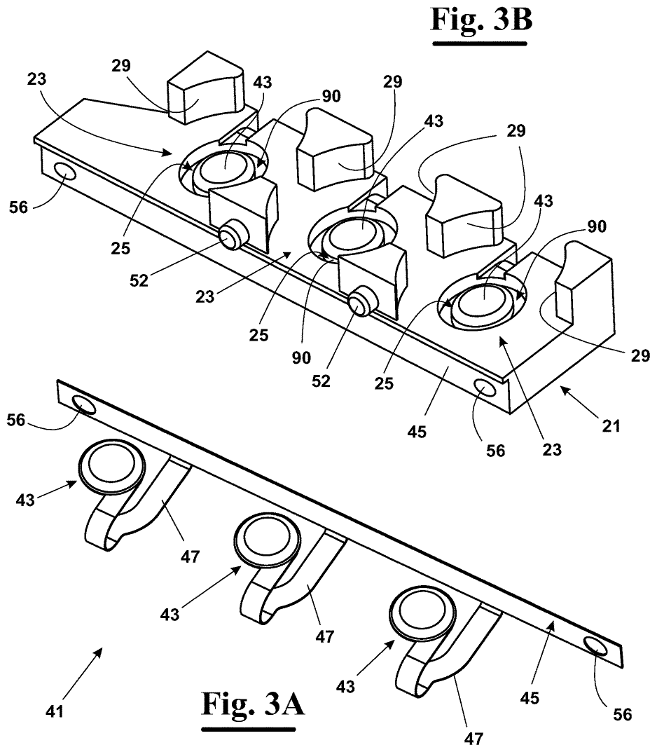

As shown in detail in FIG. 3A, the conductive element 41 of the first and the second support body 21a and 21b comprises, furthermore, a respective connection portion 45. More precisely, each connection portion 45 can be substantially laminar shaped, and can be adapted to be positioned, in use, in contact with a respective connection bar, or busbar, 31 and 32.

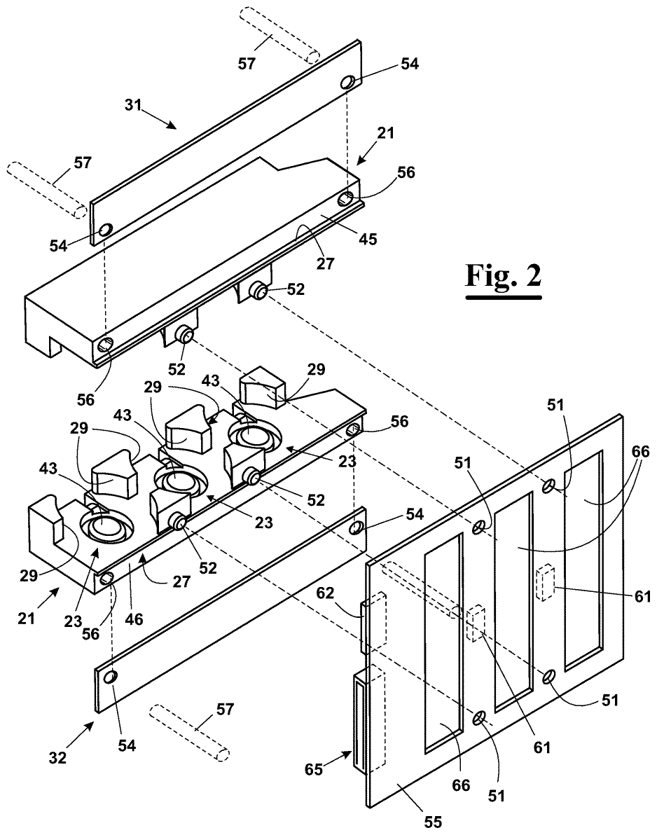

More in detail, the battery module 1, according to the invention, is provided with an engagement group 51, 52, 53, 54, 55, 56 and 57 configured to move between a disengagement configuration, where the support bodies, for example in the case of the embodiment of FIGS. 1 and 2, the first and the second support body 21a and 21b, are not engaged to each other, and an engagement configuration where the engagement group 51, 52, 53, 54, 55, 56 and 57 removably mechanically engage the support bodies 21, for example the first and the second support body 21a and 21b, in a predetermined working position. More precisely, at the aforementioned working position, the engagement group forces the connection portions 45 of the conductive elements 41 of the first and the second support body 21a and 21b to be arranged in contact con the first connection bar 31 and con the second connection bar 32, or busbar.

In particular, the second engagement elements can comprise at least a first hole 54 made in at least one between the first and the second connection bar, or busbar 31 and 32 and at least a respective second hole 53 made in at least one of the aforementioned support bodies 21a-21d. More in particular, in the aforementioned engagement configuration, the first and second holes 53 and 54 are aligned and reciprocally engaged to each other by a respective tightening element 57.

Advantageously, the engagement group, when is arranged in the aforementioned engagement configuration, is also able to mechanically force the contact portions 43 to be arranged in contact with respective positive terminals 11 or negative terminals 12 of the aforementioned plurality of cells 10. In this way, an electrical connection among the first and the second connection bar, or busbar, 31 and 32, and the aforementioned plurality of cells 10 is carried out and, therefore, the connection in parallel of these latter with no need to provide any welding among the components, as, instead, is necessary in the prior art battery modules. Therefore, the battery module 1, according to the invention, unlike analogous prior art products, can be easily and completely disassembled in a non-destructive way, and allows to inspect the different parts which form the same, and, in case, to provide a replacement of the same, and, therefore, to quickly and easily assemble them together again, once that the ordinary or extraordinary maintenance operation is finished.

In particular, the battery module 1, according to the invention, comprises at least a temperature sensor 61 to detect the temperature at a determined detection zone of the battery module 1, in such a way to detect the temperature of a determined number of cells 10, or of all the cells 10 of the aforementioned plurality, and to generate a corresponding temperature signal. Furthermore, at least an adjustment element of the balancing current 62, for example a resistance, is provided. More precisely, when the system detects that a cell, or a group of cells, has reached a predetermined maximum value of the voltage, the energy of that section is “diverted” towards the adjustment element of the balancing current, for example the resistance.

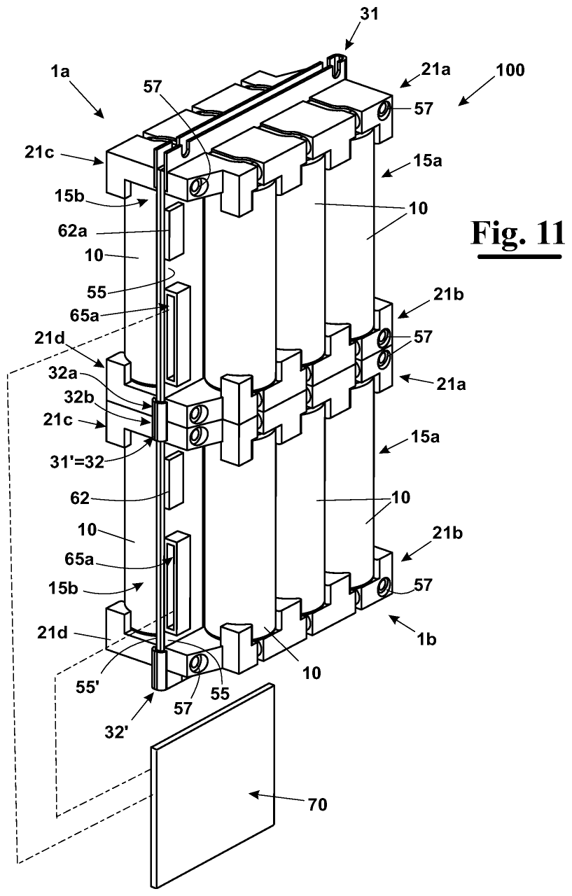

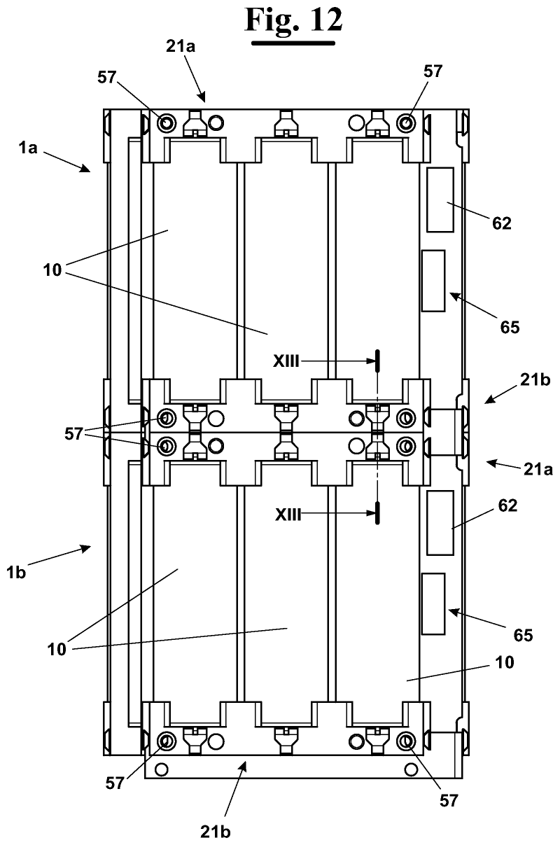

The aforementioned signal of temperature is, then, sent by the or each temperature sensor 61 to an external BMS unit 70 (see FIG. 11) which provides to elaborate the same. More precisely, the or each temperature sensor 61 and the or each adjustment element of the balancing current 62 are, advantageously, connected to the battery management unit 70 through at least one connector 65 which provides to connect the others by a wired connection.

In preferred embodiment of the invention, the aforementioned engagement group comprises at least a support plate 55 and first engagement elements 51, 52 configured to removably mechanically engage the or each support plate 55 to the plurality of support bodies 21, for example to the first and to the second support body 21a and 21b, in particular at the same side of the plate 55. In particular, the first engagement elements 51 and 52 can provide at least an engagement hole 51 made at the support plate 55, as diagrammatically shown for example in FIG. 2, or, alternatively, at the support bodies 21, and at least a protruding portion 52, for example 2 engagement pins 52, configured to protrude, in particular along a direction transversal to the or each plate 55, and to engage in respective engagement holes 51 made at the support plate 55, or alternatively at the support bodies. More precisely, the aforementioned protruding portions 52, preferably integral to the respective support body 21a-21d, are adapted to carry out a centering action of the different components of the battery module 1 in such a way to guarantee that they are correctly positioned one with respect to the other.

Preferably, the engagement group can comprise, furthermore, second engagement elements 53 and 54 adapted to removably and in a way that can be dismantled mechanically engage the first and second connection bars 31 and 32 to a respective support body 21. For example, both the connection bars 31 and 32 and the support bodies 21, and the aforementioned connection portions 45 can be provided with respective holes 53, 54 and 56 which, in the aforementioned working position, are coaxially arranged or, however, superimposed to each other and wherein tightening elements 57 which are diagrammatically shown in FIG. 2 can be provided, for example 4 bolts, or studs, each of which adapted to be engaged at the aforementioned holes 53, 54 and 56 aligned to each other to tighten among them the connection bars 31 and 32, the aforementioned support bodies 21, and the respective conductive elements 41. Therefore, once that the different components of the battery module 1 are positioned in a correct relative position owing to the presence of the aforementioned protruding portions 52, it is possible to tighten all of them in the aforementioned relative position by the tightening elements 57.

More precisely, as shown in detail in FIG. 8, the or each support plate 55 and 55′, and the first and the second connection bar, or busbar, 31 and 32 can be configured to partly superimposed to each other, for example at opposite end portions 55a, 55b and 55′a and 55′b, of the support plate 55 and 55′, in such a way to carry out a mechanical engagement of the same. As shown for example in FIG. 2, at the face that will be positioned in contact with the connection bar 31, or 32, the support body 21 can be provided with a “step” 27 or protruding portion on which the connection bar can be arranged abutted. In this way, it is guaranteed that the connection bar 31, or 32 is positioned in a correct working position.

For example, the opposite ends 55a, 55b of the or each support plate 55 and 55′, can be adapted to engage with a determined clearance, or making a positive engagement, at a passageway 35 of which each connection bar, or busbar, 31 and 32 is provided. In view of the above, the engagement group 51-57 allows to make a firm and steady mechanical connection among the connection bars 31 and 32, the support bodies 21 and the or each support plate 55, 55′, of which, in particular, the support plate 55 is an element of mechanical connection among the support bodies, for example between the first and the second support body 21a and 21b.

The or each support plate 55, 55′ can be provided with one or more elongated apertures 66, or grooves, in particular longitudinal, configured to house, in use, a portion of a respective cell 10 of the aforementioned plurality, in particular for reducing the transversal whole encumbrance of the battery module 1, according to the invention.

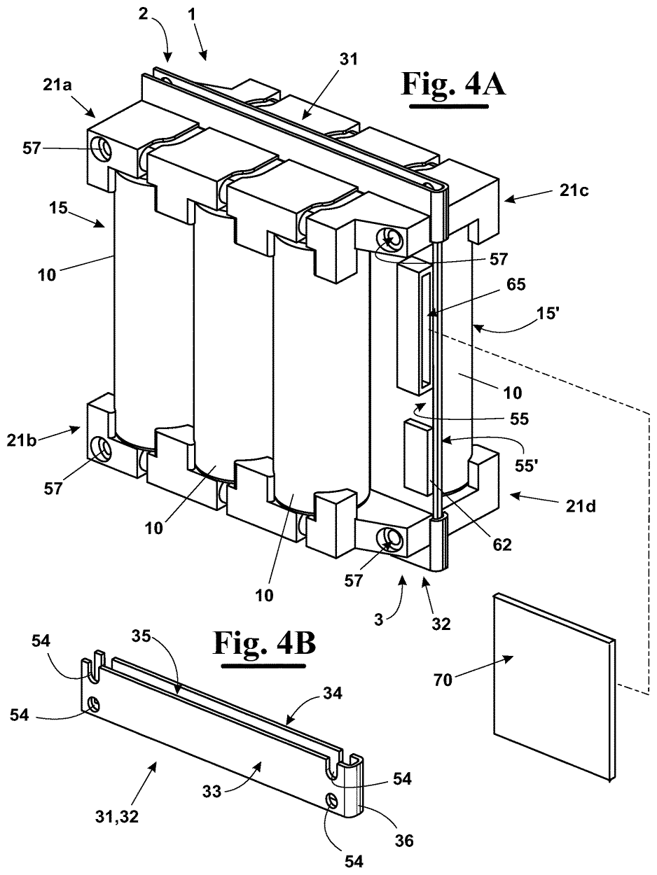

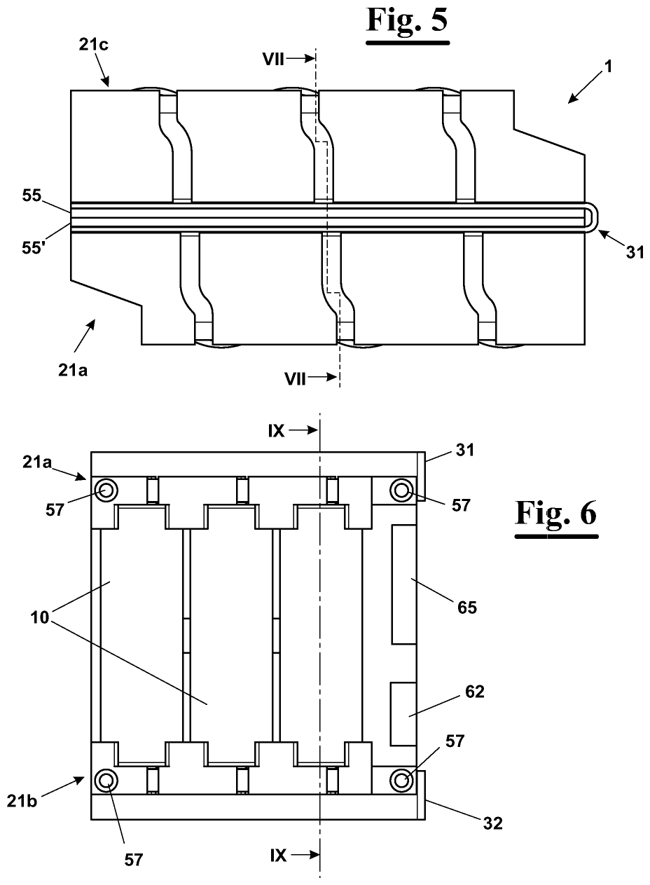

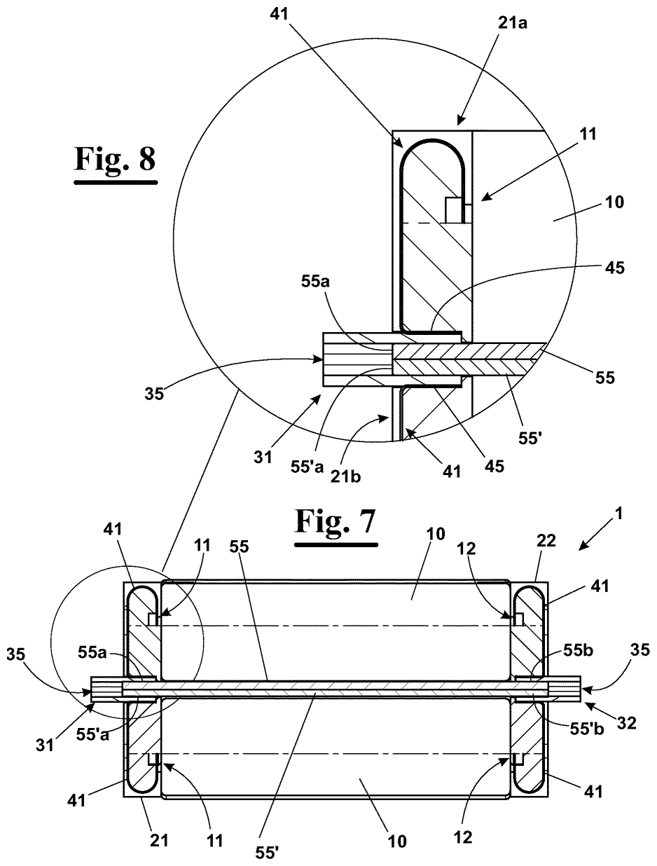

In the embodiments that are diagrammatically shown in the FIGS. from 4A to 10, the plurality of cells 10 of the battery module 1 comprises a first and a second row 15a and 15b of cells 10, in particular parallel to each other. In this case, the first and second connection bars, or busbars, 31 and 32, will, advantageously, have a geometry such to electrically connect among them, respectively, all the positive terminals 11 of the first and of the second row 15a and 15b of cells 10 and the negative terminals 12, for example having a substantially “U-shaped” longitudinal cross section. More precisely, as it is shown in detail in FIG. 4B, the connection bars 31 and 32 have, preferably, a first and a second thin plate portion 33 and 34 superimposed and connected to each other at a respective end by a linking portion 36. More precisely between the first and the second thin plate portion 33 and 34 a passageway 35 is formed.

In this case, the battery module 1, in addition to the first and the second support body 21a and 21b, comprises a third support body 21c positioned at the opposite side of the first support body 21a with respect to the first connection bar 31, or busbar and a fourth support body 21d positioned at the opposite side of the second support body 21b with respect to the second connection bar 32. More precisely, the support body 21c comprises a third plurality of housing portions 23, for example 3 housing portions 23, each of which configured to house, in use, a first end portion 13 comprising the positive terminal 11 of a respective cell 10 of the second row 15b of the aforementioned plurality of cells 10. Analogously, the fourth support body 21d comprises a fourth plurality of housing portions 23, for example 3 housing portions 23. Each housing portion 23 housed, in use, a second end portion 14 comprising the negative terminal 12 of a respective cell 10 of the aforementioned second row 15b of the plurality of cells. According to what is foreseen by the invention, between the first and the second body 21a and 21b a predetermined number of cells 10 can be housed. This number can be equal or less than the number of cells 10 which can be housed between the third and the fourth support body 21c and 21d, if present in the battery module 1.

More in detail, the third and the fourth support body 21c and 21d comprise a respective conductive element 41 also this made of a conductive material. In particular, the conductive element 41 of the third support body 21c comprises a respective plurality of contact portions 43, for example 3 contact portions 43, each of which arranged, in use, adjacent to a respective positive terminal 11 of a respective cell 10 of the second row 15b of the aforementioned plurality of cells 10, whilst the conductive element 41 of the fourth support body 21d will be provided with a same number of contact portions 43, for example 3 contact portions 43, but each of these will be arranged, in use, in contact with a respective negative terminal 12 of a respective cell of the aforementioned second row 15b of the plurality of cells 10.

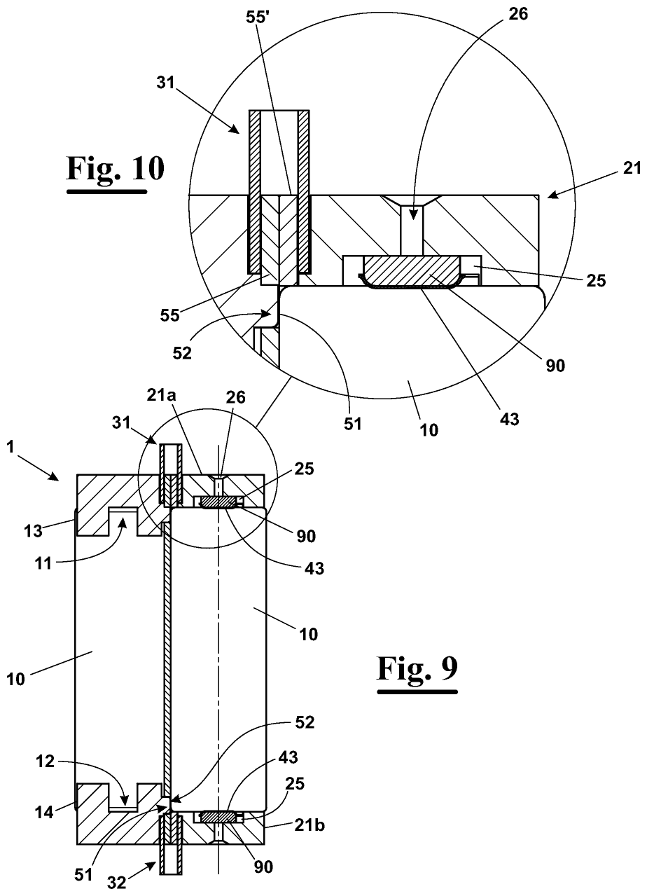

As shown in detail in particular in the FIGS. 9 and 10, at least a support body among the aforementioned plurality of support bodies 21a-21d can be provided with a cavity 25 atta ad house a respective contact portion 43 of the respective conductive element 41. In particular, at each cavity 25 an elastic element 90 can be provided. This can be made of a material having a controlled pliability, for example made of synthetic rubber, or an elastomeric material, and be arranged to resiliently force the respective contact portion 43 towards the positive terminal 11, or the negative terminal 12, of the respective cell 10, along a push direction 110 axial to the cell 10, in such a way to guarantee the electrical connection among these components.

In particular, as for example diagrammatically shown in the FIGS. 3A and 3B, the plurality of contact portions 43 adapted to be positioned at the same support body 21, can be connected by a plurality of secondary connection portions 47 to the same connection portion 45. More in particular, each secondary connection portion 47 can be a shaped elongated element, for example bent.

In particular, each secondary connection portion 47 can be configured in such a way to be pliable, or substantially pliable, in a controlled way with respect to the aforementioned connection portion 45.

In a possible embodiment foreseen by the invention and still diagrammatically shown in the FIGS. 9 and 10, each support body 21a-21d can be provided with one or more apertures 26, for example branched to provide an elastic element 90 with more branches as described below with reference to the FIGS. from 14 to 18, each of which adapted to put in communication the external environment with the aforementioned cavity 25. In this way, according to one of the possible technological solutions foreseen by the invention, it is possible, once positioned, to inject the elastomeric material at the melted state into the aforementioned cavity 25 through the aforementioned apertures 26, and, therefore, anchoring the aforementioned elastic elements 90 to the respective support body 21, in particular through a co-molding process. Then, each conductive element 41 is positioned in a respective working position with respect to the respective support body 21a-21d to which is advantageously constrained, in particular by a positive engagement, with the respective contact portions 43 positioned adjacent to the respective elastic elements 90.

In particular, during the movement of the engagement group from the disengagement configuration to the engagement configuration, each elastic element 90 can be arranged in an elastically compressed configuration. More precisely, at the moment of engaging the different components by the engagement group, in particular at the moment of engaging the support bodies to the or each support plate 55, 55′, by the aforementioned first engagement elements, the presence of the elastic elements 90, gives the possibility to have a certain clearance to easily position the cells 10 among the aforementioned support bodies 21a-21d per poi, once the first engagement elements 51 and 52 have been arranged in the engagement configuration, exert an elastic force pushing the respective contact portion 41 towards the respective positive or negative terminal 11, 12, guaranteeing in this way the correct electrical contact among the same. Then, the second engagement elements 53 and 54, until that moment arranged for example in a respective reference position, but not yet tightened, can be tightened in order to further guarantee a firm anchoring of the different parts which form the battery module 1. As diagrammatically shown in FIG. 4B the second engagement elements 54 can comprise at least a hole 54 made in at least one between the first and the second connection bar, or busbar 31, 32.

In particular, if 2 plates 55 and 55′ are provided, each of which associated to a respective row 15a, or 15b, of the cells 10, these can be arranged facing with each other, advantageously adjacent to respective surfaces. In this case, at least one of the two plates 55 and 55′, at the face opposite to the face adjacent to the other plate 55′, 55, is, advantageously, provided with the or each temperature sensor 61, and/or the or each balancing element 62, and/or the connector 65. In an alternative embodiment of the invention, each support plate 55 and 55′is, advantageously, provided with at least a respective temperature sensor 61, and/or with at least a respective balancing element 62, and/or with at least a respective connector 65. In a possible embodiment a first support plate 55 can be provided with one or more of the aforementioned sensors, or balancing elements, and the second plate 55′ can be provided with sensors and electronic elements in general of different type, in particular an electronic element of the type that is present at the present time in the BMS unit of known type. In this way, it is possible to “lighten” and further simplify the BMS unit. Advantageously, between the first and the second plate 55 and 55′a conductor of power, which is not shown in the figures for simplicity, can be present.

Furthermore, in the case of a first and a second support plate 55 and 55′ opposite to each other, each plate can be provided with respective engagement elements to engage each support plate to at least a respective support body 21, preferably to a couple of support bodies. More precisely, the support plate 55 can be engaged by the aforementioned support elements, to the first and to the second support body 21a and 21b, and the second support plate 55′ to the third and to the fourth support body 21c and 21d (see FIG. 4A).

According to a further aspect of the present invention that is diagrammatically shown in FIG. 11, a battery pack 100 comprises at least a first and a second battery module la and 1b, for example as described above with reference to the embodiments shown in the FIGS. from 4A to 10. In particular, the battery pack 100 provides that the first battery module la comprising a first and a second row 15a and 15b of cells 10, in particular of cylindrical type, is positioned above the second battery module 1b, also this comprising a first and a second row 15a and 15b of cells 10, advantageously of cylindrical type. The battery modules 1a and 1b provide, preferably, respectively a first and a second plate 55 and 55′ as described above with reference to FIG. 4A. Each battery module 1a and 1b, furthermore, provides 4 support bodies 21a-21d, each of which, advantageously, engaged to a respective support plate 55, or 55′ of the respective module 1a, or 1b, as described above with reference to the FIGS. from 4A to 10.

According to what is foreseen by the invention, the second connection bar 32 of the first battery module 1a coincides, in this case, with the first connection bar 31′ of the second module 1b. More precisely, the second connection bar 32 of the first battery module 1a comprises an upper connection portion 32a adapted to be connected to the negative terminals 12 of the first battery module 1a and a lower connection portion 32b configured to be connected to the aforementioned plurality of positive terminals 11 of the second battery module 1b. In this way, it is possible to connect the cells 10 of each battery module 1a, and 1b in parallel to each other, and to connect the cells 10 of the first battery module 1a in series with the cells 10 of the second battery module 1b. In this case, the second connection bar 32 of the first battery module la can be provided with a first couple of holes 54 to mechanically connect the same to at least a support body 21b of the first module 1a and to a second couple of holes 54 to connect, instead, mechanically, the second connection bar 32 of the first module 1a to at least a support body 21′a of the second module 1b.

The battery pack 100, according to the present invention, provides, furthermore, a battery management unit 70, or BMS from the English acronyms “Battery Management System”, which is diagrammatically shown in FIG. 11. This, as it is known, has the function of controlling the correct functioning of the cells 10 of the battery pack 100 and, in particular, to redistribute the charge among the single groups of cells, each of which comprising a predetermined number of cells, if the voltage of one group of cells exceeds of a predetermined value the voltage of the other cells 10 of the battery pack 100, or of the respective battery module 1a, or 1b. According to the number of battery modules 1 connected in series as described above with reference to FIG. 11, will be possible, therefore, to obtain the desired total voltage of the battery pack 100.

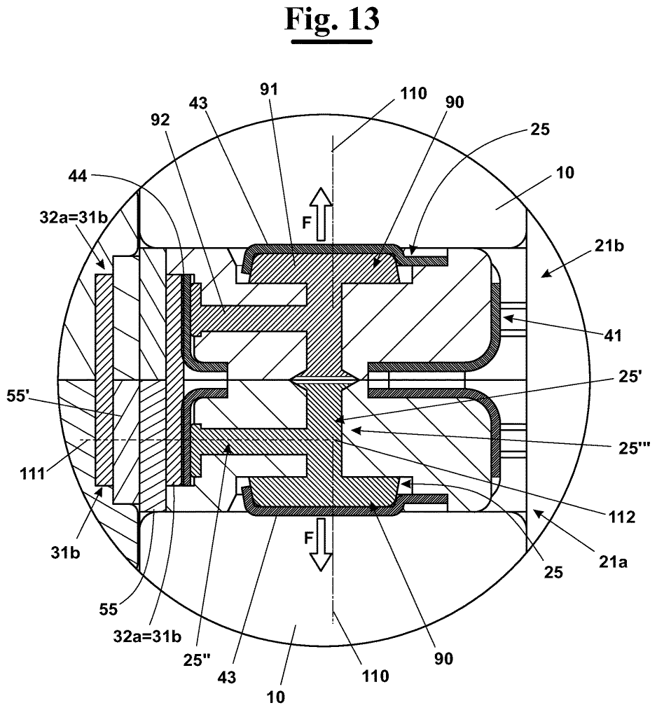

As diagrammatically shown in FIG. 13, the elastic element 90 can comprise a first push portion 91 arranged to elastically push the contact portion 43 of the conductive element 41 against the terminal 11, or 12, of the respective cell 10 along an axial direction 110, and a second push portion 92, or lateral branch, arranged to elastically push a supplementary contact portion 44 of the conductive element 41 against the connection bar 31, or 32, and, therefore, to force this against the first and the second support plate 55 and 55′ guaranteeing the electrical contact among the different components.

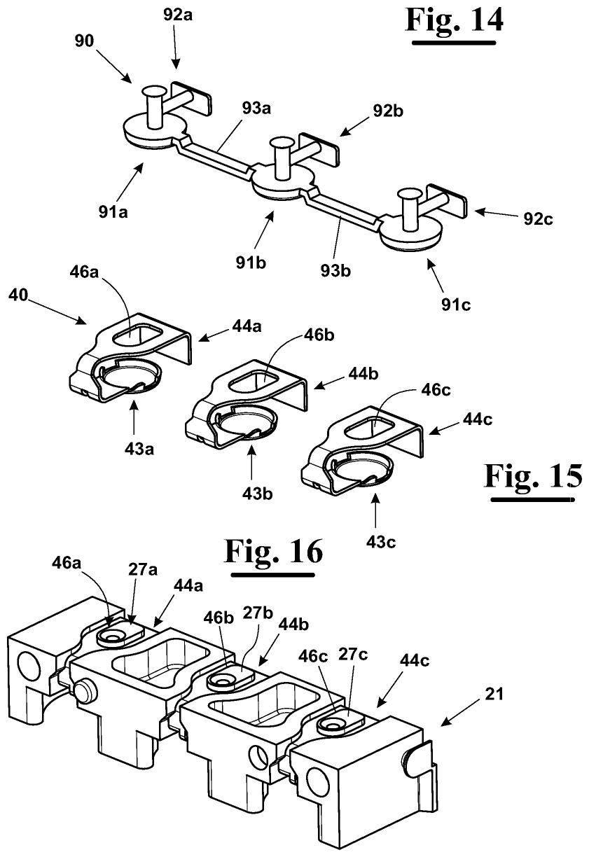

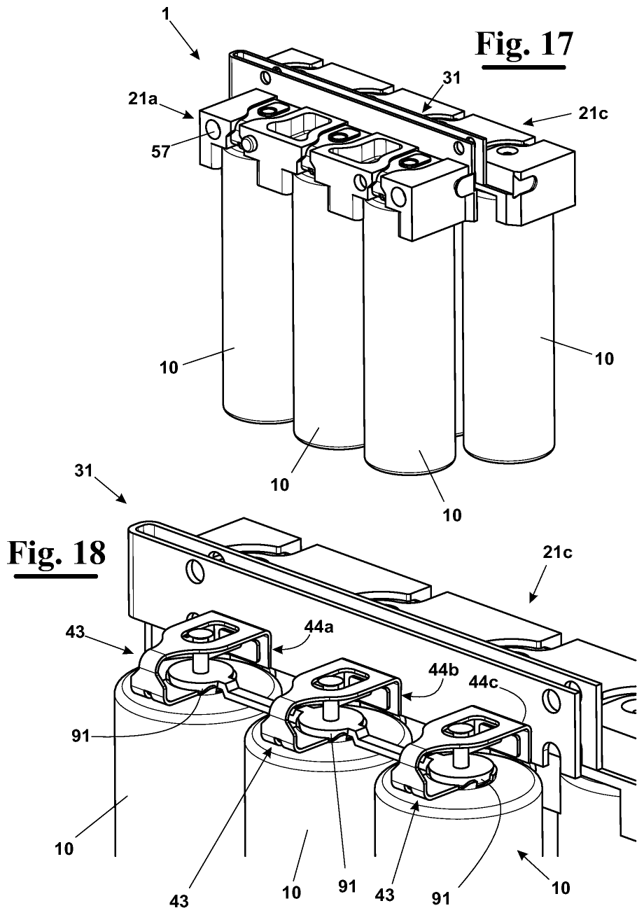

As diagrammatically shown in FIG. 15, the conductive element 41 associated to each support body 21a-21d can comprise a plurality, for example 3 contact portions 43a-43c made of a conductive material that are not physically connected to each other. In this case, therefore, a contact group 40 of contact portions 43 for each support body 21a-21d is provided. In particular, the elastic element 90 can comprise a single element made of an elastomeric material comprising a respective plurality, for example 3 prime push portions 91a-91c arranged to resiliently force a respective first contact portion 43a-43c of the conductive element 41 against a respective positive or negative terminal 11 or 12 of a respective cell 10, and a plurality of second push portions, for example 3 second push portions 92a-92c arranged to resiliently force a respective second contact portion 44a-44c against the first, or the second, connection bar or busbar 31, or 32, in particular along a push direction 111, inclined at a predetermined angle, or orthogonal, or substantially orthogonal, with respect to the aforementioned axial direction 110.

In particular, analogously to what described above with reference to the FIGS. from 1 to, each support body 21a-21d can be provided with at least an aperture 26, not shown in FIG. 16, through which the elastomeric material at the melted state can be introduced into the aforementioned cavity 25, which, in the case that is shown in the FIGS. from 13 to 18 has a main branch 25′ oriented along a first direction, coincident with the aforementioned axial direction 110, and at least a secondary branch 25″ oriented along a second direction 111 inclined, or orthogonal, with respect to the aforementioned first direction 110. In this way, during the step of overmolding or co-molding, both the or each first push portion 91a-91c, and the or each second push portion 92a-92c of the elastic element 90, diagrammatically shown in the FIGS. 13 and 14, are obtained.

As diagrammatically shown in the FIGS. from 13 to 18, each contact portion 43a-43c can be provided with a respective aperture 46a-46c through which, once that the overmolding of the elastic element 90 on the support body 21 is carried out, it is possible to mechanically engage each conductive element 41 al support body 21. In particular, as diagrammatically shown in FIG. 16, each aperture 46a-46c can be adapted to engage a respective engagement portion 27a-27c of the support body 21.

What described above is diagrammatically shown in FIG. 18 where the support body 21a has been removed in order to highlight some technical characteristics of the embodiments described above of the conductive element 41 and of the elastic element 90. This latter, as diagrammatically shown in FIG. 14 can comprise a plurality of elastic connection portions, for example 2 elastic connection portions 93a and 93b, each of which adapt to connect two following push portions, respectively the push portion 91a with the push portion 91b, and this latter with the push portion 91c. In particular, each connection portion 93a, 93b is formed during the overmolding or co-molding process at a supplementary portion 25″ of the cavity 25, for example oriented along a direction 112 orthogonal to the first and to the second direction 110 and 111 and, therefore, entering the sheet of FIG. 13, provided in at least one support body 21a-21d.

The use of an elastomeric material, in particular of known hardness, in all the embodiments described above and diagrammatically shown in the FIGS. from 1 to 18, guarantees to exert a known and constant force F on the surface of the terminal 11, or 12 of the cell 10, and in particular along a direction 110 axial to the cell 10. This allows to overcome the limits of the prior art solutions, for example of US2021083248, in particular the non-repeatability of the force of contact carried out by the only metallic thin plate, due to the geometric tolerances of production (shearing).

In particular, still as diagrammatically shown in FIG. 13, the technical solution of the present invention allows to push the contact portion 43 made of the conductive material, in particular the conductive thin-plate, for example made of nickel-plated copper, along the aforementioned axial direction 110, in particular with respect to the surface of contact with the cell 10 same. This solution allows, therefore, to avoid the disadvantages of the prior art solutions and in particular of the solution described in US2021083248.

The foregoing description of a specific embodiment will so fully reveal the invention according to the conceptual point of view, so that others, by applying current knowledge, will be able to modify and/or adapt for various applications such an embodiment without further research and without parting from the invention, and it is therefore to be understood that such adaptations and modifications will have to be considered as equivalent to the specific embodiment. The means and the materials to realise the different functions described herein could have a different nature without, for this reason, departing from the field of the invention. It is to be understood that the phraseology or terminology employed herein is for the purpose of description and not of limitation.

1-25. (canceled)

26. A battery module comprising:
a plurality of cells arranged according to at least one row, each cell of said plurality having a positive terminal and a negative terminal positioned at opposite ends of said cell;
a first and a second busbar, positioned at end portions of said battery module opposite to each other and configured to be respectively electrically connected to said positive terminals and to said negative terminals of said plurality of cells; and
a plurality of support bodies each of which comprising a respective plurality of housing portions configured to house, in use, a respective end portion comprising said positive terminal, or said negative terminal, of a respective cell of said plurality of cells;
wherein:
each support body of said plurality is provided with a respective conductive element made of a conductive material and comprising a respective plurality of contact portions, each contact portion of said plurality being adapted to be arranged, in use, adjacent to a respective positive terminal, or to a respective negative terminal of a respective cell of said plurality of cells;
each said conductive element comprises, furthermore, a connection portion wherein at least a support body of said plurality is provided with a cavity arranged to house, in use, a respective contact portion of said conductive element;
an engagement group is, furthermore, provided configured to move between a disengagement configuration, where said plurality of support bodies are not engaged to each other, and an engagement configuration where said engagement group is arranged to removably mechanically engage said plurality of support bodies in a predetermined working position, where said connection portions of said conductive elements are mechanically forced to be arranged in contact with said first busbar, or with said second busbar, and each said contact portion to be arranged in contact with a respective positive terminal or with a respective negative terminal of said plurality of cells, in such a way to make the electrical connection between said first and second busbars, and said plurality of cells; and
at each said cavity an elastic element is provided that is made of an elastomeric material and is arranged to resiliently force said respective contact portion towards said positive or negative terminal of said respective cell along a direction axial to said cell, in such a way to guarantee said electrical connection.

27. The battery module according to claim 26, wherein said elastic material is a thermoplastic elastomeric material.

28. The battery module according to claim 26, wherein said elastic material is Styrene-ethylene-butylene-styrene (SEBS).

29. The battery module according to claim 26, wherein said engagement group comprises:
at least a support plate; and
first engagement elements configured to removably mechanically engage said or each support plate to at least a support body of said plurality of support bodies.

30. The battery module according to claim 26, further comprising:
at least one temperature sensor configured to detect the temperature of at least a part of said plurality of cells and to generate a corresponding temperature signal;
at least one adjustment element of the balancing current configured to balance the voltage at least at a part of said plurality of cells if the value of the voltage exceeds a predetermined threshold value; and
at least one connector configured to connect said or each temperature sensor and/or said or each adjustment element of the balancing current to a battery management unit or BMS external to said battery module,
wherein said or each adjustment element of the balancing current and said or each connector are mounted on said or each support plate.

31. The battery module according to claim 29, wherein:
said engagement group comprises second engagement elements configured to removably mechanically engage at least one between said first and said second busbar, to said plurality of support bodies, and
said second engagement elements comprise at least one first hole made in at least one between said first and said busbar and at least a respective second hole made in at least one of said support bodies, said first and second holes being positioned aligned to each other in said engagement configuration and being reciprocally engaged to each other by a respective tightening element.

32. The battery module according to claim 26, wherein:
said plurality of support bodies comprise a first support body and a second support body;
said engagement group is configured to engage said first and second support bodies to the same side of the same support plate;
said plurality of cells comprise a first row of cells and a second row of cells; and
said plurality of support bodies further comprise:
a third support body positioned at the opposite side of said first support body with respect to said first busbar; and
a fourth support body positioned at the opposite side of said second support body with respect to said second busbar.

33. The battery module according to claim 26, wherein said first engagement elements comprise:
a plurality of engagement holes made in said support plate, or in at least a part of said plurality of support bodies; and
a plurality of protruding portions arranged to transversally protrude from said plurality of support bodies and configured to engage, in said engagement configuration of said engagement group, in respective engagement holes of said support plate.

34. The battery module according to claim 27, wherein:
said plurality of cells comprise a first and a second row of cells;
said first and second busbars, comprise, respectively, a first and a second thin plate portion superimposed and connected to each other at a respective end by a linking portion;
between said first and said second thin plate portion, a passageway is formed; and
said or each support plate is arranged to be positioned at opposite end portions in contact to said first and second busbars, at said respective passageways, to provide a mechanical coupling.

35. The battery module according to claim 26, wherein said first and second busbars, have a substantially “U-shaped” longitudinal cross section.

36. The battery module according to claim 26, wherein each support body is provided with a plurality of apertures, each of which is adapted to put in communication the external environment with said cavity, through said apertures said melted elastomeric material being adapted to be injected into said cavity in such a way to anchor said elastic elements to the respective support body.

37. The battery module according to claim 26, wherein said or each support plate is provided with at least one elongated aperture, configured to house, in use, a portion of a respective cell of said plurality, in such a way to reduce the total transversal dimension.

38. The battery module according to claim 26, wherein:
said plurality of contact portions are adapted to be positioned at the same support body and are connected by a plurality of secondary connection portions to the same connection portion; and
wherein each secondary connection portion is configured in such a way to be pliable, or substantially pliable, in a controlled way with respect to said connection portion.

39. The battery module according to claim 26, wherein said conductive element is made of nickel-plated copper.

40. The battery module according to claim 26, wherein:
each said elastic element comprises at least:
a first push portion arranged to elastically push said contact portion of said conductive element against said positive terminal or said negative terminal of a respective cell along an axial direction; and
a second push portion arranged to elastically push a supplementary contact portion of said conductive element against said first busbar or said second busbar;
and
said elastic element comprises a plurality of elastic connection portions, each of which is arranged to connect two push portions to each other.

41. The battery module according to claim 40, wherein each support body is provided with a cavity having a plurality of branches, each of which is arranged to provide a respective first push portion, or a respective second push portion, or a respective connection portion of said elastic element through an overmolding or co-molding process.

42. A battery pack comprising:
a first and at least a second battery module according to claim 26; and
a battery management unit configured to receive said temperature signals and/or operate said or each adjustment member to adjust the balancing current between said plurality of cells, wherein:
said first battery module is positioned above said second battery module;
said second busbar, of said first battery module coincides with said first busbar, of said second battery module and comprises:
an upper connection portion configured to be electrically connected to said negative terminals of said plurality of cells of said first battery module; and
a lower connection portion configured to be electrically connected to said positive terminals of said plurality of cells of said second battery module; and
said upper connection portion and said lower connection portion are arranged to connect in series said plurality of cells of said first battery module and said plurality of cells of said second battery module.

43. A method for manufacturing a battery module, comprising the steps of:
positioning a plurality of cells according at least one row, each cell of said plurality having a positive terminal and a negative terminal positioned at opposite ends;
disposing of a first and a second busbar, positioned at end portions of said battery module opposite to each other and configured to be respectively electrically connected to said positive terminals and to said negative terminals of said plurality of cells;
disposing of a plurality of support bodies each of which comprising a respective plurality of housing portions configured to house, in use, a respective end portion comprising said positive terminal, or said negative terminal, of a respective cell of said plurality of cells, each support body of said plurality being provided with a respective conductive element made of a conductive material and comprising a respective plurality of contact portions and a respective connection portion, each contact portion of said plurality being adapted to be positioned, in use, adjacent to a respective positive terminal, or to a respective negative terminal of a respective cell of said plurality of cells; and
removably mechanical engaging of said plurality of support bodies to mechanically force said connection portions of said conductive elements to be arranged in contact with said first busbar, or with said second busbar, and each said contact portion to be arranged in contact, with a respective positive terminal or with a respective negative terminal of said plurality of cells, in such a way to make the electrical connection between said first and second busbar, and said plurality of cells, wherein:
said removably mechanical engaging is carried out by resiliently forcing by an elastic element made of an elastomeric material, which is housed within a cavity made in at least a support body of said plurality, a respective contact portion of said conductive element towards said positive or negative terminal of said respective cell along a direction axial to said cell, in such a way to guarantee said electrical connection.

44. The method according to claim 43, wherein said elastomeric material is positioned within said cavity by introducing said melted elastomeric material through at least one aperture made in said support body and adapted to put in communication said cavity with the external environment.

45. The method according to claim 44, wherein said cavity comprises:
at least a main branch oriented along a first direction to form through an overmolding or co-molding process, a respective first push portion of said elastic element, and
at least a secondary branch oriented along a second direction inclined at a predetermined angle, or orthogonal, with respect to said first direction to form through said overmolding or co-molding process, a respective second push portion of said elastic element.

46. The method according to claim 45, wherein said or each cavity further comprises at least a supplementary portion oriented along a third direction and arranged to form through an overmolding or co-molding process, a respective connection portion of said elastic element arranged to connect two first push portions of said elastic element following to each other.
